(19) United States
(12) Patent Application Publication
(10) Pub. No.: US 2015/0216109 A1
(43) Pub. Date: Aug. 6, 2015

(54) METERING ASSEMBLY WITH INDIVIDUALLY DRIVEN METERING SECTIONS

(71) Applicant: ONE PASS IMPLEMENTS INC., Langbank (CA)

(72) Inventors: Andrew Thomas Meyer, Wawota (CA); Kenneth Mathew Dlugan, Wawota (CA)

(21) Appl. No.: 14/427,941

(22) PCT Filed: Sep. 12, 2013
(86) PCT No.: PCT/CA2013/050704

§ 371 Date: Mar. 12, 2015

Related U.S. Application Data
(60) Provisional application No. 61/701,460, filed on Sep. 14, 2012.

(51) Int. Cl. A01C 7/08; A01C 19/02; A01C 7/20; A01C 15/00

(52) U.S. Cl. CPC A01C 7/082; A01C 15/00; A01C 19/02; A01C 7/20

(57) ABSTRACT

A product metering assembly for receiving a product from an air seeding supply source, metering the product and dispensing the metered product to an air seeding apparatus is provided comprising a meter housing having a first end for receiving the product, a number of meter rolls disposed at or near the first end for metering the product, and a second end for dispensing the metered product to the air seeding apparatus; and a number of individual drive devices, each drive device operably associated with each meter roll to rotate each meter roll separately and apart from other meter rolls; whereby the drive device can be set to rotate the meter roll at a predetermined speed (rpm) or to stop the rotation of the meter roll.

### FIELD OF THE INVENTION

The present invention relates generally to a metering assembly for an air seeder for dispensing a particulate product such as seed, fertilizer, inoculants, or the like, and, more particularly, to a metering assembly having individually driven metering sections for dispensing a desired apportionment of a metered product.

### BACKGROUND OF THE INVENTION

An air seeding apparatus for crop farming is typically mounted on a trailer towed behind a tractor or other farming machinery. The air seeder generally includes at least one product tank which is used to hold particulate material to be deposited into the ground. Often these tanks contain a number of compartments so that a single product tank can hold more than one type of particulate material (e.g. one compartment can contain seed while another contains fertilizer). The product tank dispenses particulate material to a metering assembly that controls the amount of the particulate material that is being routed to the air seeding apparatus by an air distribution system. In many agricultural applications, particulate materials, such as seed, fertilizer, inoculants and other seed treatments, are applied to a field in controlled amounts either simultaneously or at different times.

The amounts of these particulate materials must be carefully metered and controlled because the amount of particulate material that reaches the ground is usually critical in order to optimize crop yields. Additionally, these particulate materials often constitute costly inputs to an agricultural farm and it is often very beneficial and cost effective to efficiently make use of the this particulate material.

One conventional metering assembly for an air seeder for dispensing product from a product tank or hopper for delivery to the soil is shown in FIG. 1 (Prior Art). Air seeders generally employ pneumatic distribution systems that may deliver only one product or may separately deliver two products, for example, seed and fertilizer. FIG. 1 shows a conventional metering assembly 10 that may deliver metered seed and fertilizer separately from separate product tanks or hoppers 140 through one of two sets of primary distribution lines 162, 164. This arrangement is commonly referred to as a “double shoot” and allows for both products to be simultaneously, but separately, applied to a field. It is understood, however, that the metering assembly 10 can also be used with a “single shoot” arrangement as well.

Metering assembly 10 includes volumetric meter roller 100 which may be geared to the wheels of the air seeder trailer to dispense a fixed volume of product per unit of linear distance traveled by the air seeder. It is understood that the meter roller could also be driven hydraulically, electrically or pneumatically. The meter roller 100 slides into the metering assembly 10 through slot 110. As shown in FIG. 1, the volumetric unitary meter roller 100 has an axial bore therethrough and comprising a plurality of individual meter rolls 102. The individual meter rolls are all driven by a common shaft 120. The product dispensed by the unitary meter roller 100 is then introduced into an air stream at primary distribution manifold 166. Fluidized product is carried under air pressure by primary distribution lines (162, 164) to a group of secondary distribution manifolds (not shown), which in turn distribute product through secondary distribution lines to seed/fertilizer boots mounted behind ground openers on the tilling implement.

Typically, each secondary distribution manifold services a number of seed/fertilizer boots, and as such each secondary distribution manifold has product intake requirements proportional to the number of ground openers and seed/fertilizer boots serviced. Since the total number of ground openers of the tilling equipment is often not evenly divisible by the number of secondary distribution manifolds of the air seeder, at least one secondary distribution manifold may be servicing a different number of seed boots than other secondary distribution manifolds of the same tilling equipment.

Therefore, in order to evenly distribute product across the width of the tilling equipment, product seen by a secondary distribution header that, for example, is servicing 7 seed/fertilizer boots, should be less than (⅞) the amount of product seen by a secondary distribution header servicing 8 seed/fertilizer boots. The meter upstream in the pneumatic distribution system from the secondary distribution header servicing fewer seed/fertilizer boots should therefore supply a correspondingly lesser volume of product compared to other meters. However, as shown in FIG. 1, all meter rolls employed in dispensing a product from a particular hopper typically share, and are driven by, a common shaft.

Since the individual meter rolls are all running from a common shaft (as a unitary meter roller) and, thus, at the same rotational speed (rpm), several manufacturers have developed different displacement meter rolls to compensate. For example, CA 2,616,239 solves this problem by changing the displacement volume of the meter roller by having a number of meter rolls with different volumes to approximate the change in the number of outlets on the distribution head. Another manufacturer in the air seeding industry utilizes changing the length of the meter roller thereby having the same effect with respect to the total displacement per revolution.

In addition, it may be desirable to have one or more of the secondary distribution headers dispense a different amount of product than other distribution headers due to the particular contour of the ground, quality of the soil at a particular region or when turning the implement.

In some instances, it may also be beneficial to be able to completely stop the rotation of some or all of the individual meter rolls of the unitary meter roller so that seeding/fertilizing overlap does not occur, e.g., to prevent reseeding of a previously seeded area. This is referred to as sectional control and one such means for controlling the rotation of the individual meter rolls is described in CA 2,685,239, which describes the use of individual clutches to stop the rotation of each meter roll.

There is a need in the crop farming industry to provide a metering assembly that, in conjunction with a pneumatic distribution system and tilling equipment, can both vary the amount (volume) of product being dispensed during seeding and, when encountering overlap, prevent the product from being dispensed completely.

### SUMMARY OF THE INVENTION

The present invention provides a metering assembly comprising a plurality of individual meter rolls whereby each meter roll is individually operated by a rotation means such as individual motors so that each roll can be individually controlled. Thus, the rotational speed or rpm of each meter roll can be individually set in order to control the overall volume of product being dispensed from that meter roll. Further, each meter roll can be instantly stopped when sectional control is required to avoid overlap. By adding the ability to control the individual seed and/or fertilizer rates by varying the rpm per roll, an operator can now improve the benefits of sectional control to variable seeding and fertilizer rates. Thus, in addition to being able to seed/fertilize based on land shape, the operator can also seed and fertilize based on land quality.

The present invention is especially important due to the fact that the typical ‘air seeding’ toolbar width is ever increasing and thus it is common for a single pass of the toolbar to travel over significantly different soils. By way of example, a hilltop is typically drier than most areas of the field and, as such, has a different soil nutrient level as well. As the toolbar passes over the hilltop, the optimum seed and fertilizer rates are different from one end of the toolbar to the other. The present invention allows the operator to apply the optimum seed and fertilizer rate to each section of the toolbar based on prescription mapping of the field in common use today. Current implements can vary the product application rate in the direction of travel but not across the direction of travel.

Thus, in accordance with an aspect of the invention, a product metering assembly is provided for receiving a product from an air seeding supply source, metering the product and dispensing the metered product to an air seeding apparatus, comprising:

a meter housing having a first end for receiving the product, a number of individual meter rolls disposed at or near the first end for metering the product, and a second end for dispensing the metered product to the air seeding apparatus; and

a number of individual drive devices, each drive device operably associated with each meter roll to rotate each meter roll separately and apart from other meter rolls;

whereby each drive device can be set to rotate its corresponding meter roll at a predetermined speed (rpm) or to stop the rotation of the meter roll.

In one embodiment, each meter roll is configured to dispense the same volume of product. In one embodiment, the drive device comprises an electric motor. In another embodiment, the drive device comprises a hydraulic motor. In another embodiment, the drive device comprises a pneumatic motor.

In accordance with yet another aspect of the invention there is provided a product metering assembly, comprising:

at least one hopper configured to hold at least one granular product;

a plurality of primary distribution lines, each primary distribution line being configured to convey fluidized product to a corresponding secondary distribution manifold, each secondary distribution manifold being configured to dispense product to a plurality of seed/fertilizer boots; and

a number of meter rolls, each meter roll capable of being individually rotated at a predetermined speed (rpm) or stopped by means of a drive device, for metering a predetermined amount of granular product to a corresponding primary distribution line.

In one embodiment, the predetermined amount of granular product corresponds to the number of seed boots on the corresponding secondary distribution manifold. In another embodiment, at least one of the meter rolls is stopped in order to avoid overlap.

In one aspect, the metering assembly can be used to meter particulate product at varying rates to meet either/both of the following: different seed/fertilizer requirements of seeded areas as determined by soil testing and mapping used in conjunction with a sectional control technology air seeding system, and different numbers of secondary outputs without the use of different displacement rollers in either a sectionally controlled or non-sectionally controlled air seeding system.

### BRIEF DESCRIPTION OF THE DRAWINGS

The features and advantages of the invention will become more apparent from the following detailed description of the embodiment with reference to the attached diagrams wherein:

FIG. 1 is an exploded perspective view of a prior art metering apparatus for metering granular product having a unitary meter roller and a primary distribution manifold;

FIG. 2 is a top plan view of a tool bar of an air seeder having both a seven (7) outlet secondary distribution head (manifold) and an nine (9) outlet secondary distribution head (manifold);

FIG. 3a is a top plan view of a nine (9) outlet secondary distribution head (manifold) which feeds product to nine (9) secondary distribution lines.

FIG. 3b is a top plan view of a seven (7) outlet secondary distribution head (manifold) which feeds product to seven (7) secondary distribution lines.

FIG. 4 is a front view of a metering assembly to dispense product, in accordance with one embodiment of the invention.

FIG. 5a is an exploded perspective view of an embodiment of a drive device of the present invention.

FIG. 5b is an exploded cross-sectional view of a drive device of the present invention.

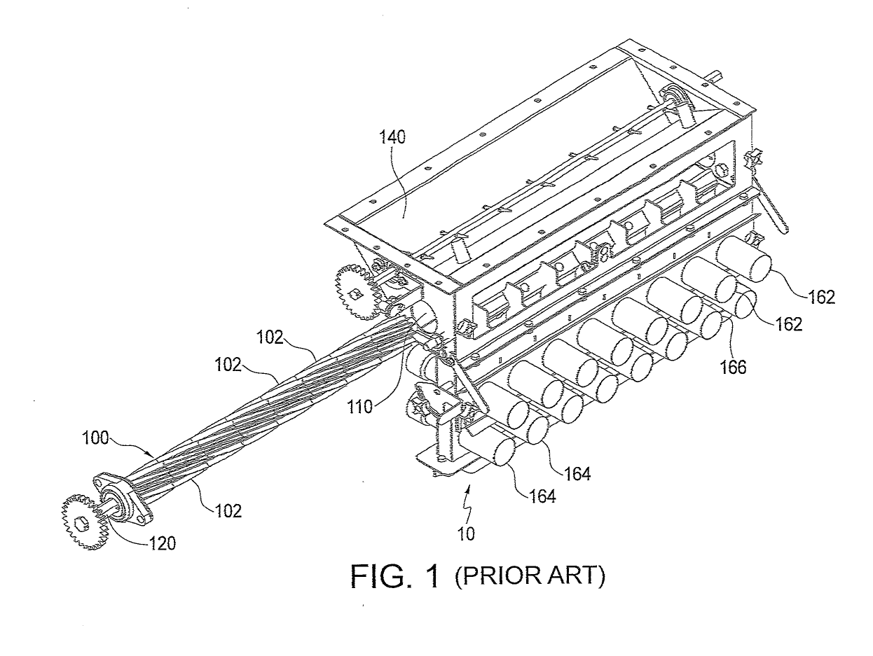

It will be noted that in the attached diagrams like features bear similar labels.

### DETAILED DESCRIPTION OF THE EMBODIMENTS

The detailed description set forth below in connection with the appended drawings is intended as a description of various embodiments of the present invention and is not intended to represent the only embodiments contemplated by the inventors. The detailed description includes specific details for the purpose of providing a comprehensive understanding of the present invention. However, it will be apparent to those skilled in the art that the present invention may be practiced without these specific details.

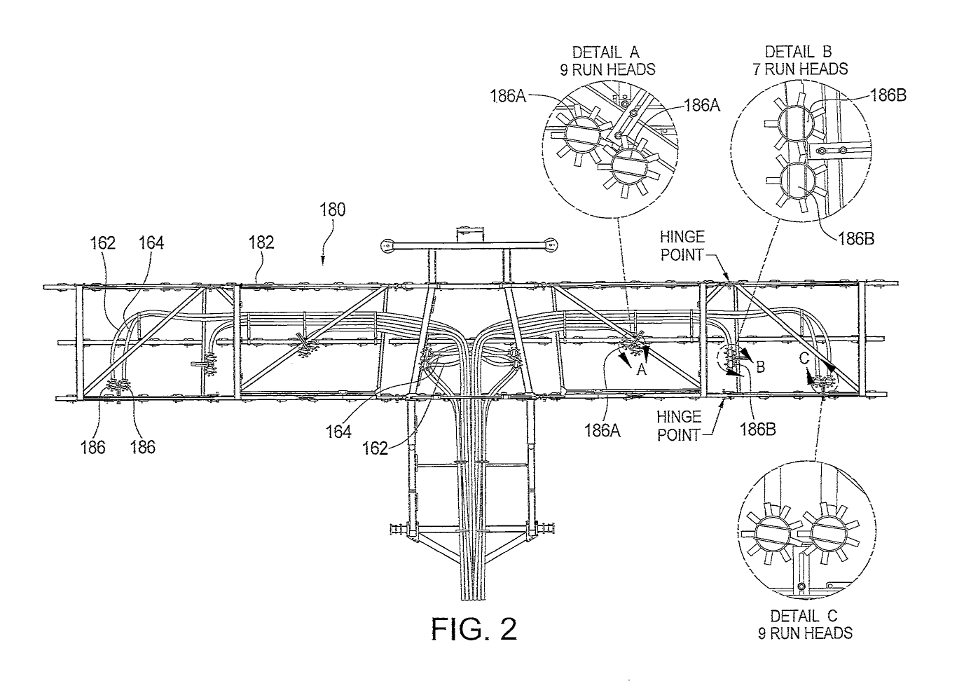

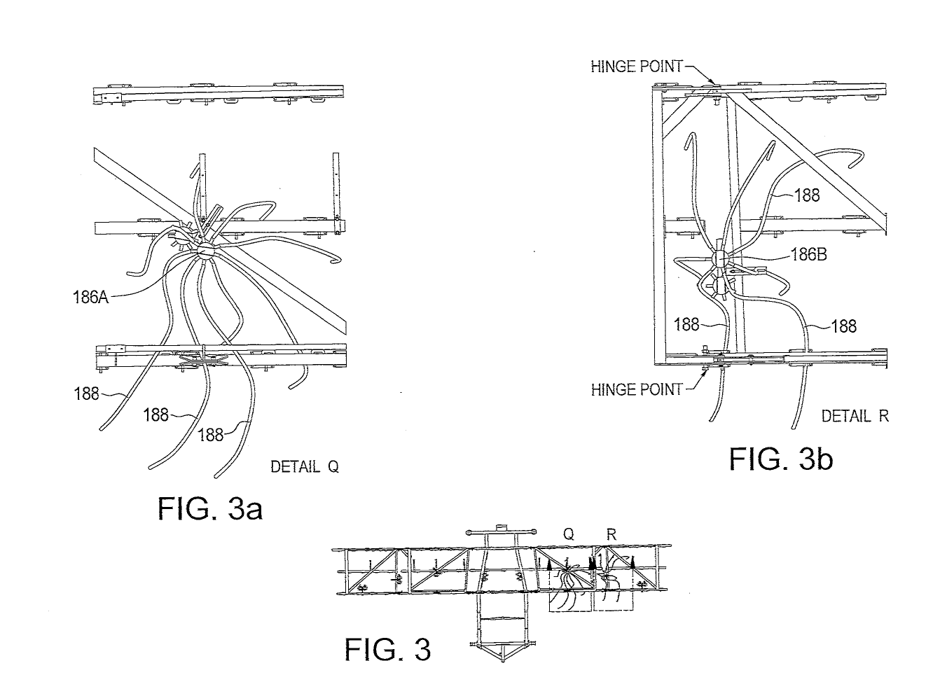

FIG. 2 shows a toolbar 180 commonly used with air seeders having a frame 182 carrying a number of seeding/fertilizing arms (not shown), each arm having furrow openers, seed/fertilizer boots and the like, as is known in the art. As can be seen in FIG. 2, each primary distribution line (162, 164) is operably connected to a secondary distribution head 186. However, there may exist two types of secondary distribution heads or manifolds, for example, a nine outlet secondary distribution head 186A (feeding nine (9) arms) and an seven (7) outlet secondary distribution head 186B (feeding seven (7) arms). Thus, in order to get even distribution of seed and/or fertilizer (product) across the entire width of toolbar 180, less product needs to be distributed from secondary distribution head 186B, which feeds only seven arms, versus secondary distribution head 186A, which feeds nine (9) arms. This can be seen more clearly with reference to FIGS. 3a and 3b.

FIG. 3a shows secondary distribution head 186A, which feeds nine (9) secondary distribution lines 188. Each secondary distribution line 188 is operably connected to an arm having seeding/fertilizing tools for dispensing product into the soil. FIG. 3b shows secondary distribution head 186B, which feeds seven (7) secondary distribution lines 188. Each secondary distribution line 188 is operably connected to an arm having seeding/fertilizing tools for dispensing product into the soil. Thus, less product needs to be dispensed to secondary distribution head 186E than to secondary distribution head 186A (i.e., only 7/9 as much product).

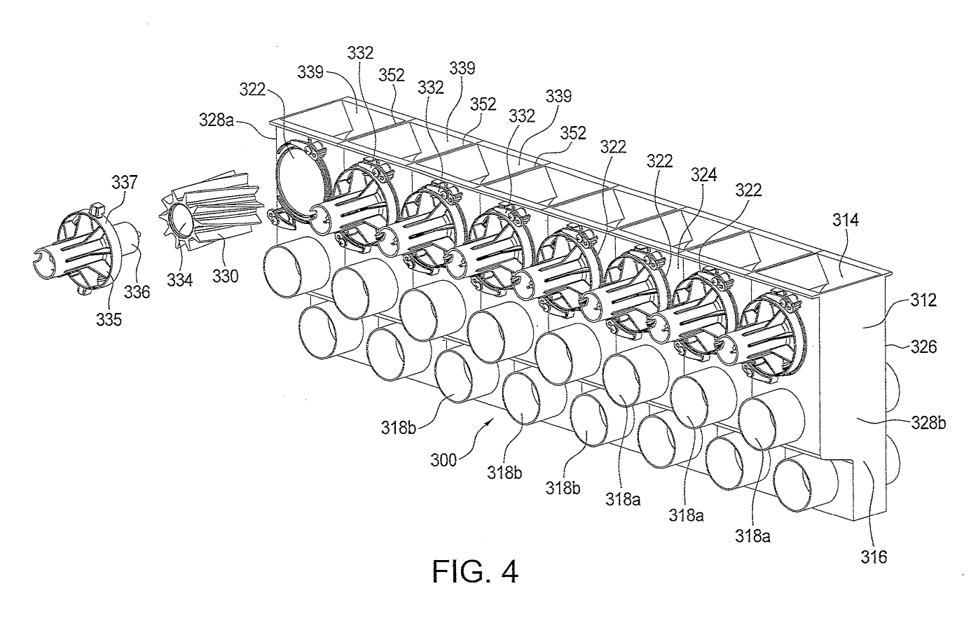

Such varied distribution of product can be accomplished with a metering assembly as shown in FIG. 4.

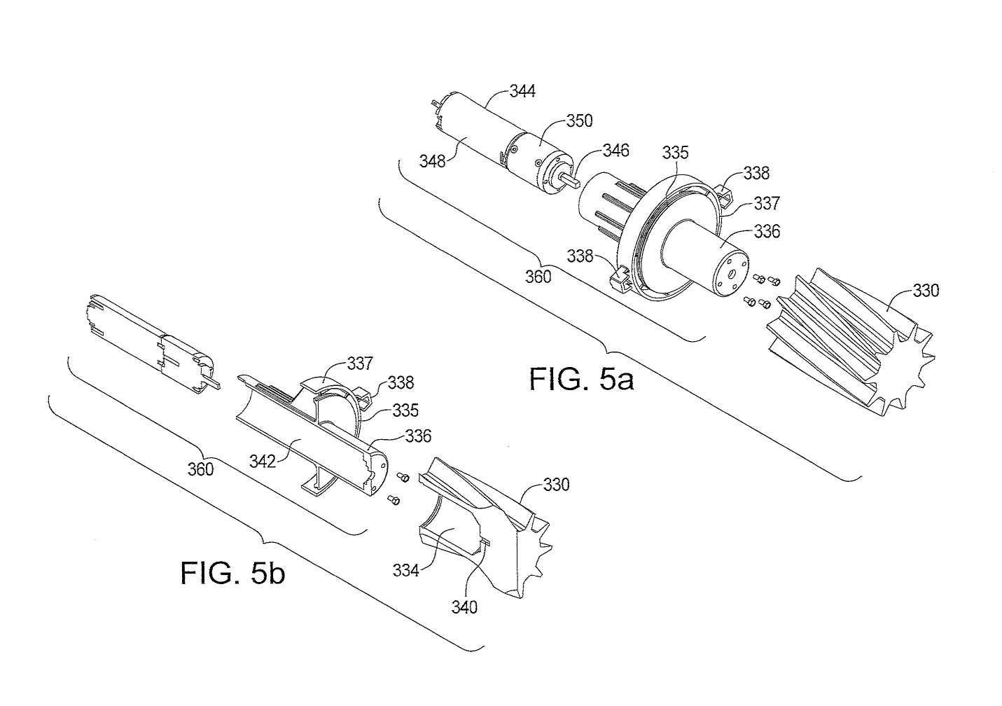

With reference now to FIGS. 4, 5a and 5b, metering assembly 300 comprises meter housing 312 having an open first end 314 at or near the top of the meter housing 312, a second end 316 at or near the bottom of the meter housing 312, a front wall 324, a back wall 326 and two side walls 328a and 328b. At or near bottom end 316 are a plurality of primary distribution lines, the top primary distribution lines 318a for distributing one product (e.g., seed) and the bottom primary distribution lines 318b for distributing a second product (e.g., fertilizer). It is understood, however, that there may only be a single row of primary distribution lines when only a single product is being dispensed by an implement. The primary distribution lines 318a, 318b distribute metered product to a plurality of secondary distribution lines (not shown) and ultimately to corresponding seeding/fertilizing tools (not shown) for dispensing the product into the soil. The front wall 324 has a number of meter roll cavities 322 through which individual meter rolls 330 are fitted and fixed in place as follows. Each meter roll 330 comprises an axial bore 334.

An individual drive device 360 is provided to rotate each meter roll 330 separately comprising drive housing 335 having a tubular member 336 at one end that fits through the axial bore 334 of the meter roll 330. Drive housing 335 further comprises an attachment ring 337 having lock nubs 338 so that the meter roll 330 and drive housing 335 can be affixed to the front wall 324 of the meter housing 312 by lock tab 332. Drive housing 335 further comprises a cavity 342 configured to receive drive mechanism 344. Drive mechanism 344 comprises a gear box 350 and electric motor 348 for rotating drive shaft 346, which drive shaft 346 can fit into notch 340 of the roll 330. It is understood, however, that other drive devices can be used which can be operatively connected to the meter roll.

Rotating body 350 is driven by motor 348, which motor can be an electric motor, a hydraulic motor, a pneumatic motor and the like, as is known in the industry. The speed of rotation (rpm) of rotating member 350 can be set according to the desired conditions for dispensing particulate material. Thus, each drive device 360 can be individually and variably adjusted. In one embodiment, the drive device 360 operates in response to a pre-programmed or computerized GPS control means. In another embodiment, the drive device 360 can be manually controlled. In another embodiment, soil type maps or soil sampling maps can be used to create variable rate application maps. This allows a prescribed rate of particulate material to be applied at each location within the field based on soil test results. It is understood, however, that any controller or multiple controllers known in the industry can be used to individually and variably control all of the drive devices 360.

In the embodiment as shown in FIG. 4, each meter roll/drive housing assembly is housed in its own sub-compartment 339, which sub-compartment 339 is formed by providing sub-compartment walls 352 to separate one sub-compartment from the next. In this embodiment, there are a total of eight (8) sub-compartments 339 in the metering assembly 300. Further, each sub-compartment 339 has two (2) primary distribution lines, 318a and 318b, one line which can be selected when wishing to dispense seed and the other line when wishing to dispense fertilizer. Each pair of primary distribution lines 318a/318b in each sub-compartment 339 then feeds a number of secondary distribution lines via a secondary distribution head. When the metering assembly 300, as shown in FIG. 4, is used with tool bar 180 as shown in FIG. 2, each sub-compartment 339 will meter and distribute product (either seed or fertilizer) to a secondary distribution head which either feeds product to seven (7) arms having tillage tools (i.e., secondary distribution head 186B) or nine (9) arms having tillage tools (secondary distribution head 186A).

Thus, in accordance with an embodiment of the invention, the metering assembly 300 can be used in a situation where, as shown in FIG. 2, a tool bar of a seeding apparatus has a plurality of secondary distributions heads where at least one of the distribution heads is distributing product to a lesser number of arms having seeding/fertilizing tools than the other secondary distribution heads. Thus, it would then be desirable to meter/dispense less product when feeding product to secondary distribution head 186B (seven (7) arms) than secondary distribution head 186A (nine (9) arms). Hence, in this instance, the electric motor that is operably attached to the meter roll that is metering and dispensing product to secondary distribution head 186B, can be adjusted such that such the rate/speed of rotation of the meter roll is slowed, thereby metering and dispensing less product.

In another embodiment of the invention, there may be an instance where it is desirable to not meter and dispense any product to a secondary distribution head 186, for instance, if the tool bar is traveling over a part of the field that has already been seeded/fertilized. In this instance, it would be desirable to totally shut off the electric motor that is operably attached to the meter roll that is metering and dispensing product to that secondary distribution head 186. Hence, overlap is readily avoidable.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

We claim:

1. A product metering assembly for receiving a product from an air seeding supply source, metering the product and dispensing the metered product to an air seeding apparatus, comprising:
a meter housing having a first end for receiving the product, a number of meter rolls disposed at or near the first end for metering the product, and a second end for dispensing the metered product to the air seeding apparatus; and
a number of individual drive devices, each drive device operably associated with each meter roll to rotate each meter roll separately and apart from other meter rolls;
whereby each drive device can be set to rotate the meter roll at a predetermined speed (rpm) or to stop the rotation of the meter roll.

2. The product metering assembly as claimed in claim 1, wherein the drive device comprises an electric motor.

3. The product metering assembly as claimed in claim 1, wherein the drive device comprises a hydraulic motor.

4. The product metering assembly as claimed in claim 1, wherein the drive device comprises a pneumatic motor.

5. The product metering assembly as claimed in claim 1, wherein the metering housing comprises a number of sub-compartments and each meter roll and corresponding drive device is housed in its corresponding sub-compartment.

6. The product metering assembly as claimed in claim 5, wherein each sub-compartment comprises at least one primary distribution line.

7. The product metering assembly as claimed in claim 5, wherein each sub-compartment comprises two primary distribution lines.

8. The product metering assembly as claimed in claim 6, wherein the at least one primary distribution line feeds at least one secondary distribution line.

9. The product metering assembly as claimed in claim 8, wherein the at least one primary distribution line feeds the at least one secondary distribution line by means of a distribution manifold configured to dispense product to a number of seed/fertilizer boots.

10. The product metering assembly as claimed in claim 1, whereby the drive devices can be set by means of a controller.

11. The product metering assembly as claimed in claim 1, whereby the drive devices can be manually set.

12. A product metering assembly, comprising:
at least one hopper configured to hold at least one granular product;
a plurality of primary distribution lines, each primary distribution line being configured to convey the at least one product to a corresponding secondary distribution manifold, each secondary distribution manifold being configured to dispense the at least one product to a number of seed/fertilizer boots; and
a number of meter rolls, each meter roll capable of being individually rotated at a predetermined rotational speed (rpm) or stopped, for metering a predetermined amount of the at least one granular product to a corresponding primary distribution line.

13. The product metering assembly as claimed in claim 12, wherein the predetermined amount of granular product corresponds to the number of seed/fertilizer boots on the corresponding secondary distribution manifold.

14. The product metering assembly as claimed in claim 12, wherein at least one of the meter rolls is stopped in order to avoid overlap.

15. The product metering assembly as claimed in claim 12, wherein each meter roll is rotated by means of a corresponding drive device.

16. The product metering assembly as claimed in claim 15, wherein the drive device comprises an electric motor.

17. The product metering assembly as claimed in claim 15, wherein the drive device comprises a hydraulic motor.

18. The product metering assembly as claimed in claim 15, wherein the drive device comprises a pneumatic motor.

19. The product metering assembly as claimed in claim 12, wherein the at least one granular product is seed, fertilizer or both seed and fertilizer.
